(19) United States
(12) Patent Application Publication
(10) Pub. No.: US 2005/0032966 A1
(43) Pub. Date: Feb. 10, 2005

(54) Polymeric nanocomposite

(76) Inventors: Jawk Meijer, Wierden (NL); Elmar Wiejack-Symann, Dinslaken (DE)

Correspondence Address: VENABLE, BAETJER, HOWARD AND CIVILETTI, LLP, P.O. BOX 34385, WASHINGTON, DC, 20043-9998, US

(21) Appl. No.: 10/492,797

(22) PCT Filed: Oct. 11, 2002
(86) PCT No.: PCT/NL02/00653

Related U.S. Application Data
(60) Provisional application No. 60/330,800, filed on Oct. 31, 2001.

(30) Foreign Application Priority Data
Oct. 17, 2001 (EP) 01203923.6
Apr. 24, 2002 (EP) 02076623.4

(51) Int. Cl. C08K 3/04; C08K 9/00

(52) U.S. Cl. 524/495; 523/215

(57) ABSTRACT

The invention relates to a process for the preparation of a polymeric nanocomposite, comprising a polymer selected from the group comprising nylon, polyester and polyurethane, and comprising graphite. The process results in a nanocomposite, comprising 5-20 wt. % of graphite, said nanocomposite having both ESD- and FR-properties. The invention also deals with equipment, at least partially made of nanocomposite.

The present invention relates to a process for the preparation of a polymeric nanocomposite, said nanocomposite comprising a polymer selected from the group comprising nylon, polyester and polyurethane, said nanocomposite also comprising graphite.

Such a process is known from an article in Journal of Polymer Science, pages 1626-1633, 2001, and written by Yu-Xun Pan et. al. This article deals with the preparation of a nylon/graphite nanocomposite. This process results in a nylon composite being electrically conductive. The article does not only not deal with the use of such composite, it also fails to recognize that in areas where also flame retardancy is a key issue, such a composite does not meet the qualification for a flame/retardant product.

There are several major applications for such polymeric nanocomposite, especially in areas where reduction of friction and/or of weight is important ((partial) replacement of metal parts by plastic parts).

The reduction of friction and/or of weight may well result in deterioration of those properties which go along with the replaced part, especially for products obliged to have antistatic (protection from electrostatic discharge; ESD) as well as flame retarding (FR) properties.

The present process overcomes these deficiencies in providing an inventive process for the preparation of a polymeric composite, which fulfils the above mentioned needs.

This goal is achieved in a process, comprising the following steps:
a) mixing the liquid monomer(s) for the polymer, or a liquid oligomer thereof, with an intercalated graphite using a specific mixing energy of at most 1 kW/m³,
b) degassing the resulting mixture for a period of at least 5 minutes under a pressure of at most 50 kPa,
c) polymerizing said mixture in the presence of a suitable catalyst system, the process resulting in a polymeric nanocomposite, comprising 5-20 wt % of delaminated graphite.

The elements of the process steps of the present invention will be dealt with below.

a) The process starts with mixing the precursor(s) of the final polymer in liquid form with an intercallated graphite, said mixing being with a reduced amount of energy, the specific mixing energy being at most 1 kW/m³, more preferred at most 0.75 kW/m³. Initially the mixture is relatively “viscous”; the mixing has to be continued until this mixture has become homogeneous. There are several methods known in the art to detect the moment of the obtainance of a homogeneous mixture, like visually or measuring the torque of the stirrer, used for mixing. Monomers suited for the preparation of a polymer nanocomposite, wherein the polymer is selected from the group comprising nylon, polyester and polyurethane, are well known in the art. As an example of a monomer for nylon can be mentioned caprolactam, for the preparation of nylon-6; the skilled man of art knows the monomer(s) to be used for in-situ polymerization to the mentioned polymeric nanocomposite. The monomer(s) can be either suited for the preparation of homopolymers as well as for the preparation of copolymers, like an impactresistant nylon/polyether blockcopolymer. The skilled man is aware of suitable monomers therefor. An alternative is the use of mixed monomers for a nylon/nylon mixture, like a combination of caprolactam and laurinolactam, resulting in a nylon-6/nylon-12 mixture.

The monomer(s) need(s) to be in liquid form, as a result of which often the monomer(s) need(s) to be brought in said form by a melt-process. For said caprolactam this means that a temperature of at least 70° C. is needed, before the caprolactam is liquid. Depending on the monomer, the skilled artisan can select the temperature at which said mixing should take place.

Not only monomer(s) can be used in the present process, but also a liquid oligomer of the intended polymer can be used, again depending on the nature of the polymer and the related oligomer. Addition of a separate impact modifier can also be done at this stage; an example of such a modifier is jeffamine, like KU2-8112 of Bayer. In general the viscosity of the monomer(s) or oligomer should not exceed 50 mPa.s. As the graphite to be used in the process of the present invention, any graphite-like product is useful, where the distance between crystalline layers of the graphite have been extended with a gas or liquid, resulting in an intercalated graphite; in the above mentioned literature reference referred to as graphite intercalation compound (G.I.C.). This G.I.C. is used as such in the present invention. An example hereof is Timrex® from Timcal. As alternative also an expanded graphite (EG) can be used; this product is obtainable by rapid heating (at temperatures well above 250° C.) of a G.I.C., resulting in an expanded and exfoliated graphite. Preferably this heating results in an EG having an expansion ratio of at least 150, more preferably an expansion ratio of at least 200. Examples of such an E.G. are Nord-min® of Nordmann, Rassmann GmbH (http://www.plastverarbeiter.de/product/e958cf21 ccf.html) and E type ES 100 C. 10 from Kropfmühl A. G. The graphite preferably has an aspect ratio (=length/thickness ratio) of at least 100, more preferably at least 150. This results in an optimal value for both FR- and ESD-properties.

b) The mixture, resulting in step a) is to be degassed, during and/or after the mixing process, in order to facilitate the intimate mixing of the polymer precursor(s) and the graphite. Although it is possible to degas at ambient pressure, from an economical point of view said degassing is done under a vacuum of at most 50 kPa, during a period of at least 5 minutes. The lower the vacuum-pressure at the degassing step, the faster the degassing can take place. Preferably the degassing ratio (D.G.-ratio), herein defined as the ratio between the time of degassing (in minutes), and the vacuum-pressure during degassing (in kPa), is at least 1; in formula:

$$D . G . - ratio = \frac{time ( minutes )}{pressure ( kPa )} \geq 1.$$

This degassing should be performed while the precursor/graphite mixture is in liquid form.

It has surprisingly been found that with the use of a mixture of a G.I.C. and an E.G., the desired properties of the polymeric nanocomposite can even better be achieved. In doing so, one can independently accommodate for the FR and ESD properties. A process variant hereof is, that both the G.I.C. and the E.G. are mixed with the precursor(s) of the final polymer, followed by step b). An alternative is the mixing of the G.I.C. with the precursor(s), performing step b), followed by an addition of the EG to the resulting mixture, followed by a second degassing step (b)-step).

c) The degassed mixture is then polymerized in suitable equipment, optionally in the presence of a suitable catalyst system, under conditions known in the art for the polymerization to either nylon, polyester of polyurethane. As a result of the polymerization, the graphite is substantially present in delaminated form in the polymeric nanocomposite.

To achieve the goal of the present invention, the polymeric nanocomposite resulting form the described process should have a graphite content of between 5 and 20 wt. %, relative to the weight of the polymer. When using a mixture of G.I.C. and E.G., the amount of G.I.C. in the polymer can preferably be varied between 5 and 10 wt %; the amount of E.G. in the polymer can preferably be varied between 5-15 wt %. In such a combination, both the required ESD and FR properties can be obtained.

The intercalated graphite to be used in the process of the invention should have a particle size of at most 75 μm, preferred at most 25 μm, and more preferred at most 10 μm. In doing so, the effectiveness of the graphite in the obtainance of both ESD- and FR-properties is improved. The expanded graphite has a particle size of at most 200 am; preferably 80% of the particles are smaller than 150 μm.

The process of the present invention is preferably suitable for an anionic polymerization; more preferred even where this polymerization is a monocast in-mould polymerization, wherein the mixture comprising precursor and graphite is cast (poured) into a mould with a predesigned shape, where in said mould the polymerization is performed.

In preference, the process of the present invention results in a polymeric nanocomposite, based on a nylon, selected from the group comprising nylon 6, nylon 11 and nylon 12.

It has been found that the properties of the polymeric nanocomposite can be further improved by heat-annealing the composite at elevated temperatures (but below the melting point of the composite); in order to reduce the amount of residual monomer(s).

The invention also relates to a polymeric nanocomposite having both desired FR- and ESD-properties. The nanocomposite comprises as polymeric element a polymer selected from the group comprising nylon, polyester, and polyurethane; preferably the polymer is nylon, selected from the group comprising nylon 6, nylon 11 and nylon 12. The melt viscosity of the nylon, determined at 260° C., preferably is at least 8 kPa.s, as determined according to ISO 6721-10. The polymeric nanocomposite of the invention is comprising 5-20 wt. % delaminated graphite, and is having a surface resistivity of between 10⁴ and 10¹⁰ Ω/square, as well as a flame-retardancy of at least UL94V1. The surface resistivity is to be measured according to ASTMD257; the flame-retardancy according to Underwriter Laboratory Test '94. Preferably, the surface resistivity is between 5×10⁵ and 10¹⁰ Ω/square. The FR-properties can also be determined according to DIN 22100-7, in which the dripping behaviour of a specimen under fire is determined. In this test, the time for the specimen to start dripping is determined. This time should be preferably at least 15 minutes, more preferred at least 20 minutes, in order to designate the product as being flame-retardant. Also preferred is a flame-retardancy of at least UL94V0.

The polymeric nanocomposite of the present invention may also comprise conventional additives and other fillers, as they are known in the art to be used in polymeric compositions comprising nylon, polyester of polyurethane. Such additional components can comprise coulorants, reinforcing agents, fibers of polymeric or natural nature, etc. The skilled man of art knows which to select.

The polymeric nanocomposite of the present invention is very well suited, due to its ESD- and FR-properties, to be used in equipment and materials to be used in areas where these properties play a significant role. Public authorities have evermore demanding requirements on such equipment and materials, in order to prevent casualties and material damage in case of fire and/or electrostatic problems.

Especially in underground mining activities, and more dedicated in coalmining activities, these requirements play a significant role. The polymeric nanocomposite of the present invention is able to meet these requirements and can therefor be used in such equipment and materials, which are at least partially made of said nanocomposite. In said mining activities, and especially in said coal mining, the equipment and materials which are at least partially made of said composite, preferably are in the form of a flight bar, and/or of a conveyer roller. These parts are extremely sensitive for ESD- and FR-conditions. To date heavier and/or much more expensive materials are used, which can now be replaced, at least partially, by equipment and materials of this invention. The referenced equipment and materials can, in a form according to the present invention, be of an hybride nature, being a combination of either the polymer and fibers of metal or of polymeric nature (like steel, or polyethylene fibers), or in which part of the equipment is made of metal (like steel or alumina) and the rest is made of the above described polymeric nanocomposite. Reference can be given to a metal-in-polymer product, as well as a metal-on-polymer product.

The polymeric nanocomposite can also be used in other types of equipment and materials, preferably in transportation elements where the FR- and ESD-properties can be exploited, preferably in transportation elements underground or in tunnels. Without limiting to the following areas of use, mentioning can be made of:
use in tunnels, like plugs or railroad equipment
use in airports, like parts for people and luggage conveyer escalators
metro and underground people transport parts for escalators
off shore activities, including sub-marines
conveyor profile covers;
   in essence in all closed areas where safety for people and materials is important; this normally being the case where there is friction between plastic parts and/or between plastic and metal parts. The present demands are for flame-retardancy of at least 15 minutes after initiation of the fire.

The invention will be elucidated by means of the following Examples, which are not meant to limit the scope of the invention.

### EXAMPLE I

In a 250 ml round-bottomed flask, 75 grams of caprolactam flakes (water concentration <100 ppm) and 5 grams of dried Timrex® KS44 graphite were added. The intercalated graphite had an average particle size of 44 μm. The flask was flushed with dry nitrogen and heated in an oil bath at 120° C. to melt the caprolactam. The mixture was stirred using a magnetic stirrer rod at 200 rpm (specific mixing energy ca. 0.1 kW/m³) and evacuated for 6 minutes at a pressure of 500 Pa. After breaking the vacuum, 1.5 grams of activator (Brüggolen® C20. C20: caprolactam hexane di-isocyanate prepolymer (CAS 5888-87-9)) was given to the mixture under stirring at 100 rpm.

In the meanwhile 3 grams of anionic catalyst (Brüggolen® C10. C10: sodium salt of aliphatic cyclic acid amide; specifically sodium salt of caprolactam (CAS 2123-24-2)) was dissolved under a dry nitrogen atmosphere in 7 grams of dry caprolactam in a laboratory reaction tube at 120° C. and homogenized by shaking.

The catalyst solution was poured to the graphite containing caprolactam/activator mixture and the mixture was homogenized by shaking for 5 seconds. The homogenized mixture was poured in a glass mould (diameter 40 mm), preheated in an oil bath at 140° C. In the mould at 140° C., polymerization of the caprolactam and crystallization of the resulting nylon-6 occurred within 10 minutes.

After demoulding, the surface resistivity of the polymer, containing 5 wt % of graphite, was 10⁹ Ω/square.

### EXAMPLES II-IV

Nylon-6 samples were produced according the procedure described in Example I except for the amount and kind of intercalated graphite. The resulting surface resistivity of the samples after demoulding was:

| | amount | surface resistivity |
|---|---|---|
| Graphite | (wt. %) | (Ω/square) |
| Timrex ® KS6 | 9 | 10⁷-10⁸ |
| Timrex ® KS44 | 10 | 10⁷ |
| Timrex ® KS6 | 15 | 10⁶ |

### EXAMPLE V

In a 2 ltr round-bottomed flask, 640 grams of caprolactam flakes (water concentration <100 ppm) and 154 grams of dried Timrex® KS44 graphite were added. The flask was flushed with dry nitrogen and heated in an oil bath at 120° C. to melt the caprolactam. The mixture was stirred at 100 rpm with a blade stirrer and evacuated for 60 minutes at a pressure of 30 kPa. After breaking the vacuum, 12 grams of activator (Brüggolen® C20) were given to the mixture under stirring at 100 rpm.

In a 1 liter round-bottomed flask, 17 grams of anionic catalyst (Brüggolen® C10) was dissolved at 120° C. under a dry nitrogen atmosphere in 380 grams of dry caprolactam and homogenized by stirring.

The catalyst solution was poured to the graphite containing activator solution and the mixture was homogenized by stirring at 100 rpm for 4 seconds. The homogenized mixture was poured in a stainless steel mould (10*10*20 cm), preheated in an oven at 140° C. After 15 minutes at 140° C., the mould was opened to obtain the polymer produced.

After demoulding, the surface resistivity of the polymer, containing 17 wt. % of graphite, was 10⁶ Ω/square.

For detecting the dripping behavior of the polymer produced, a flame with a tip temperature of 900° C. was placed at 40 mm from the product (according to DIN 22100-7). After 18 minutes the polymer started to drip. Extinguishing the flame resulted also in a switch-off of the burning of the product.

### EXAMPLE VI

The same procedure and amounts as described in Example V was used to produce a sample. After demoulding, the sample was annealed at 155° C. for 24 hrs.

The result of the annealing procedure was that in the drip test, dripping started after 25 minutes.

### EXAMPLE VII

A Nylon-6 sample was produced according to the procedure described in Example I, except for the amount and type of graphite: a mixture of 5 w % of Timrex® KS6 and 10 wt % of Nord-min® 35.

The surface resistivity of the resulting mould was 10⁸ Ω/square. The moulded product showed a clear decrease of flame intensity compared to products only filled with intercalated graphite.

1. Process for the preparation of a polymeric nanocomposite, comprising a polymer selected from the group consisting of nylon, polyester and polyurethane, and comprising graphite, this process comprising the following steps:
a) mixing the liquid monomer(s) for the polymer, or a liquid oligomer thereof, with an intercalated graphite using a specific mixing energy of at most 1 KW/m³,
b) degassing the resulting mixture for a period of at least 5 minutes under a pressure of at most 50 kPa,
c) polymerizing said mixture, optionally in the presence of a suitable catalyst system, the process resulting in a polymeric nanocomposite comprising 5-20 wt. % of delaminated graphite, relative to the weight of the polymer.

2. Process according to claim 1, wherein a mixture of the intercalated graphite and an expanded graphite is used.

3. Process according to claim 1, wherein the particle size of the intercalated graphite is at most 75 μm, preferably at most 25 μm, more preferred at most 10 μm.

4. Process according to claim 1, wherein the expanded graphite has a particle size of at most 200 μm; preferably 80% of the particles are smaller than 150 μm.

5. Process according to claim 1, wherein step c) is an anionic polymerization.

6. Process according to claim 5, wherein the polymerization is a monocast in-mould polymerization.

7. Process according to claim 1, wherein the polymer is a nylon, selected from the group consisting of nylon 6; nylon 11; and nylon 12.

8. Process according to claim 1, wherein the intercalated graphite is expanded to an expansion ratio of at least 150.

9. Process according to claim 1, wherein the intercalated graphite has an aspect ratio of at least 100.

10. Polymeric nanocomposite, comprising a polymer selected from the group consisting of nylon, polyester, and polyurethane, wherein said nanocomposite comprises 5-20 wt. % delaminated graphite relative to the weight of the polymer, and having a surface resistivity of between 5×10⁵-10¹⁰ Ω/square (according to ASTM D257), and a flame-retardancy of at least UL 94 V1 (according to Underwriter Laboratory Test 94).

11. Polymeric nanocomposite according to claim 10, wherein the polymer is a nylon, selected from the group consisting of nylon 6; nylon 11; and nylon 12, or mixtures.

12. Polymeric nanocomposite according to claim 11, wherein the nylon has a melt viscosity of at least 8 kPa.s.

13. Equipment useful in areas where electrostatic discharge and flame-retardancy play a significant role, wherein at least part of the equipment is made of the polymeric nanocomposite according to claim 1.

14. Equipment according to claim 13, suited for use in underground mining activities.

15. Equipment according to claim 14, suited for use in coal mining.

16. Equipment according to claim 14 in the form of a flight-bar.

17. Equipment according to claim 14 in the form of a conveyer roller.

18. Equipment according to claim 14, suited for use in transportation elements underground or in tunnels.

19. Equipment according to claim 13, wherein the equipment comprises a hybride combination of the polymeric nanocomposite and either:
a) a polymeric or metal fiber
b) a metal in the form of either
b1) a metal-in-polymer product, or
b2) a metal-on-polymer product.

20. Equipment according to claim 19, wherein the metal is steel or alumina.
